(19) United States
(12) Patent Application Publication
(10) Pub. No.: US 2005/0108577 A1
(43) Pub. Date: May 19, 2005

(54) Remote diagnostic system for facilities and remote diagnostic method

(76) Inventors: Kouji Nishihata, Tokuyama (JP); Kenji Nakata, Hikari (JP); Shoji Ikuhara, Hikari (JP); Hideyuki Yamamoto, Kudamatsu (JP); Hideaki Kondo, Kudamatsu (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/003,472

(22) Filed: Dec. 6, 2004

Related U.S. Application Data
(63) Continuation of application No. 09/790,691, filed on Feb. 23, 2001.

(30) Foreign Application Priority Data
Jul. 19, 2000 (JP) 2000-219695

(51) Int. Cl. H04L 9/00

(52) U.S. Cl. 713/201

(57) ABSTRACT

A remote diagnostic system and method for facilities which carry out a diagnosis on a facilities placed under management of a first company using the diagnostic system of a second company, which is connected to the facilities through a communications network and which is not placed under management of the first company. The facilities include, a storage unit which stores information classified into multiple security levels having different access rights in order to determine the scope of reply in response to an inquiry regarding information on diagnosis of the facilities, and a security level evaluation control unit to assign a new access right in response to the inquiry devoid of access right regarding the diagnosis from the second company in conformance to the degree of the event related to the inquiry.

The present application is a continuation of application Ser. No. 09/790,691, filed Feb. 23, 2001, the contents of which are incorporated herein by reference.

### BACKGROUND OF THE INVENTION

The present invention relates to a remote diagnostic system and diagnostic method for facilities and particularly a remote diagnostic system and diagnostic method which is suitable for use when the manufacturer of at least a part of the facilities and the user of said facilities are different as in a semiconductor manufacturing line. Here the term “facilities” is not limited only to the production facilities such as a semiconductor manufacturing line; it also refers to the equipment and facilities composed of a combination of various systems and components, including non-production facilities such as large sized financial systems.

### RELATED BACKGROUND ART

In recent years, systems having a remote diagnosis function using the Internet have been proposed. One of such remote diagnosis functions is disclosed in the Official Gazette of Japanese Patent Laid-Open NO. 40200/1998 where various data preset at the terminal station are sent to a remote diagnostic system installed at the center office of a service company. Remote diagnosis is started at the center office based on the data sent from the terminal station, and a new data obtained by correction of terminal equipment setting errors is sent back to the user. The system disclosed in the Official Gazette of Japanese Patent Laid-Open NO. 40200/1998 provides a operation technique of initialization, error diagnosis and data updating of the equipment connected to the terminal on the computer network or the equipment incorporating said terminal, where the equipment connected to the Internet or the equipment incorporating the terminal thereof are diagnosed for error. The equipment sends status data to the terminal, and the terminal transfers the received status data to the server on the Internet. Based on the received status data, the server diagnoses the equipment and sends the result of diagnosis to said terminal.

In such a remote diagnostic system, the user need not disclose information on equipment diagnosis which may require protecting security thereof in some cases, for example, in home electronic appliances, on the one hand. On the other hand, data related on user security may leak if three is no protection against external access for system diagnosis as in the case of the manufacturing system.

In an effort to provide a remote diagnostic system for communications equipment ensuring effective protection of the remote diagnosis, Official Gazette of Japanese Patent Laid-Open NO. 149188/1997 discloses a system comprising (1) a data creating means to create data in the center station equipment of the remote diagnostic system based on the ID number preset on the terminal equipment and to send the created data to the terminal station equipment, (2) an ID number setup means to set ID numbers on the terminal station equipment and to send the preset ID numbers to said center station equipment, (3) a data analysis means to analyze the received data and (4) a diagnostic control means to evaluate whether remote diagnosis is possible or not.

Another known system is the one where equipment for access to the LAN line is installed, and an ID (Internet Protocol) address is assigned to each system, thereby allowing a system comprising of an information processing system and diagnostic system to be configured on the network. In this case, an information processing system and maintenance diagnostic system are connected is parallel to the LAN line, and this permits access to the information processing system from other than maintenance diagnostic system with the result that user security protection is insufficient. To solve this problem, Official Gazette of Japanese Patent Laid-Open NO. 149188/1997 discloses a remote maintenance diagnostic system, wherein a maintenance diagnostic system to supervise the operation status of the system connected to the information processing system has such an independent (autonomous) network functions as network access function and supervision analysis function, and connection of said information processing system to the network is made through said maintenance diagnostic system, thereby improving security protection and reducing the system installation cost.

With ever advancing and complicating technologies, it is getting increasingly difficult to manufacture all the large sized facilities such as the semiconductor manufacturing line in one company. In an increasing number of cases, they must be manufactured with the cooperation of multiple companies or must be partly purchased from manufacturers of the manufacturing system. Consequently, to ensure a quick and accurate diagnosis of such large sized facilities, the company is required to provide detailed information on the control, maintenance and management of the facilities, on the one hand.

On the other hand, providing such information to other companies may signify leakage of company security, and the disclosure thereof is accompanied by many restrictions. Let us assume, for example, that a client having purchased a semiconductor manufacturing system from a manufacturing system manufacturer and is required to submit information by the manufacturer for the diagnosis of the system. In this case, crucial information on the client semiconductor production status or manufacturing know-how may be known to other companies leak, depending on the type of information.

In recent years, however, production and management facilities have become centralized and are large-sized. When the semiconductor manufacturing line, for example, has become faulty to disturb production under these circumstances and there is a delay in diagnosing the causes for the fault, a great economic loss will be caused by production suspension.

The conventional remote diagnostic system has no elastic, highly reliable security function enough to meet such complicated requirements.

### SUMMARY OF THE INVENTION

The object of the present invention is to provide a remote diagnostic system and diagnostic method having an elastic, highly reliable security function to ensure harmony between two requirements of protection of company security and prevention of increased economic loss in the remote diagnosis of facilities.

The present invention is characterized by a remote diagnostic system for facilities which carries out a diagnosis on the facilities placed under the management of the first company, using the diagnostic system of the second company which is connected to said facilities through a communications network and which is not placed under the management of said first company; wherein said facilities comprise a security level evaluation control means which changes the scope of reply in response to an inquiry from said diagnostic system regarding information on said facilities for diagnosis in conformance to the degree of the event related to said inquiry.

The present invention is characterized by a remote diagnostic system for facilities which carries out a diagnosis on the facilities placed under the management of the first company, using the diagnostic system of the second company which is connected to said facilities through a communications network and which is not placed under the management of said first company;
wherein said facilities comprises,
(1) a storage unit which stores said information classified into multiple security levels having different access rights in order to determine the scope of reply in response to an inquiry regarding information on diagnosis of said facilities, and
(2) a security level evaluation control means to assign a new access right in response to the inquiry devoid of access right regarding said diagnosis from said second company in conformance to the degree of the event related to said inquiry.

The present invention is characterized by a remote diagnostic system for facilities which carries out a diagnosis on the facilities placed under the management of the first company, using the diagnostic system of the second company which is connected to said facilities through a communications network and which is not placed under the management of said first company;
wherein the diagnostic system of said second company makes an inquiry about the information regarding the facilities of said first company where said information is assigned with access right in advance, and conducts diagnosis based on the obtained information,
requests said first company to provide additional information on the high order security level not assigned with access right, if additional information is required for said diagnosis, and performs diagnosis based on the additional information obtained by being assigned with a new access right from said first company.

The present invention is characterized in that the right of access to said information is classified into at least three levels;
(1) the scope of normally providing information in response to the inquiry from said the second company,
(2) the scope of restricting said access right in conformance to the degree of said event, and
(3) the scope of providing information by restricting said access right and changing the information provision format for security protection.

Another feature of the present invention is that said facilities are a semiconductor manufacturing system. The present invention provides a remote diagnostic system and diagnostic method to ensure harmony between two requirements of protection of company security and prevention of increased economic loss in the remote diagnosis of facilities.

### BRIEF DESCRIPTION OF THE DRAWINGS

FIG. 1 is a block diagram representing the configuration of a remote diagnostic system according to the present invention applied to the semiconductor manufacturing system;

FIG. 2 is a drawing representing an example of configuration of the semiconductor manufacturing system control server in the system of FIG. 1;

FIG. 3 shows an example of the table representing the information security level on the side of Company A regarding the semiconductor manufacturing system of Company A through the information security evaluation means;

FIG. 4 is a drawing showing an example of the configuration of diagnostic system of Company B in the system shown in FIG. 1;

FIG. 5 shows an example of control configuration of the semiconductor manufacturing system of Company A in the system of FIG. 1.

FIG. 6 shows an example of a vacuum processing system adopted as process treatment systems given in FIG. 5;

FIG. 7 shows a drawing illustrating a processing flow where the diagnostic system of Company B diagnoses a semiconductor manufacturing system of a client A;

FIG. 8 is a drawing illustrating the operation of the information security evaluation means;

FIG. 9 is a drawing showing an example of a specific flow of the process of allowing automatic change of the security level by the information security evaluation means of client A;

FIG. 10 is a drawing showing an example of changing the recipe format;

FIG. 11 is a drawing showing an example of analysis where failure event is a vacuum exhaust time expiration error in the process chamber;

FIG. 12 is a block diagram representing another embodiment of the remote diagnostic system where the present invention is applied to the semiconductor manufacturing system.

FIG. 13. is a drawing showing an example of analyzing the cause based on the data obtained from client A; and

FIG. 14 is a flow diagram in the case where the diagnostic program is sent and processed in step 424 shown in FIG. 7.

### DETAILED DESCRIPTION OF PREFERRED EMBODIMENTS

The following describes the embodiments according to the present invention:

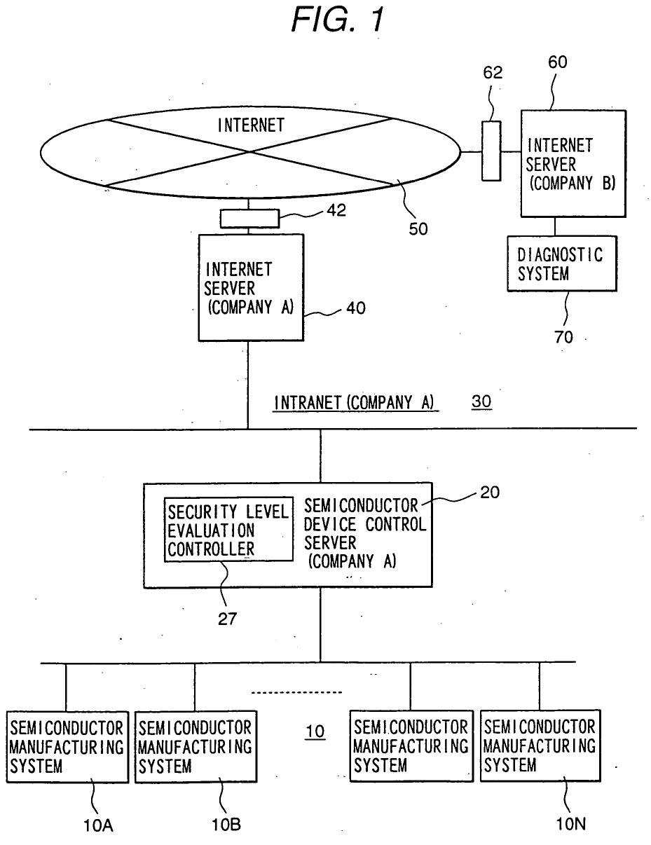

FIG. 1 is a block diagram representing the configuration of a remote diagnostic system according to the present invention applied to the semiconductor manufacturing system.

This diagnostic system carries out a diagnosis on the facilities placed under the management of the first company (company A) periodically or whenever diagnosis is required, using the diagnostic system of the second company (company B) which is connected to said facilities through a communications network and which is not placed under the management of said first company. In this embodiment, Company B is assumed as a manufacturer having produced and delivered part or the majority of the semiconductor manufacturing system of Company A. Company B can be a specialist service company to provide maintenance services of the semiconductor manufacturing system of Company A.

In this remote diagnostic system, the semiconductor manufacturing system 10(10A to 10N) of Company A for which failure is diagnosed and data are updated is connected to a semiconductor manufacturing system control server 20 comprising a control means to control all of these semiconductor manufacturing systems 10. The server 20 is connected to the Intranet 30 in Company A. It is further connected to the Internet 50 through the Internet server 40 and Firewall system 42. The Internet 50 is connected with a diagnostic system 70 comprising the diagnostic program of the semiconductor manufacturing system through Firewall system 62 of Company B and the Internet server 60 (and the Intranet).

The semiconductor manufacturing system control server 20 comprises (1) a storage unit which stores information classified into multiple security levels having different access rights in order to determine the scope of reply in response to an inquiry regarding information on the diagnosis of the semiconductor manufacturing system, and (2) a security level evaluation control means 27 to determine if a new access right should bed assigned or not in conformance to the degree of the event related to said inquiry, and to carry out processing based on the results thereof.

A general telephone line, leased communications line or communications line by fiber-optic cable is used for connection among the semiconductor manufacturing system, servers, the Internet and diagnostic system. It goes without saying that an IP address or specific ID number is assigned to each piece of equipment in advance for communications between Company A as a client and Company B as a system manufacturer.

Each of the semiconductor manufacturing system control servers 20 and 40 is composed of a computer, and is connected with a display and operation unit as an I/O means including a keyboard and mouse. Servers 20 and 40 are provided with browser software (WWW browser) to access the Internet 50 and server 60. Each of the semiconductor manufacturing systems 10 (10A to 10N) has a personal computer, and is connected with a display and operation unit as an I/O means including a keyboard and mouse.

The computer of each of the servers 20 and 40 is provided with an interface for connection with the external equipment. This interface is used for communications of data and command between the microcomputer in each computer and external equipment. It has a communications program and communications interface, and provides modulation and transmission of the data and command created by the microcomputer, and reception and demodulation of the data and commands sent through telephone line.

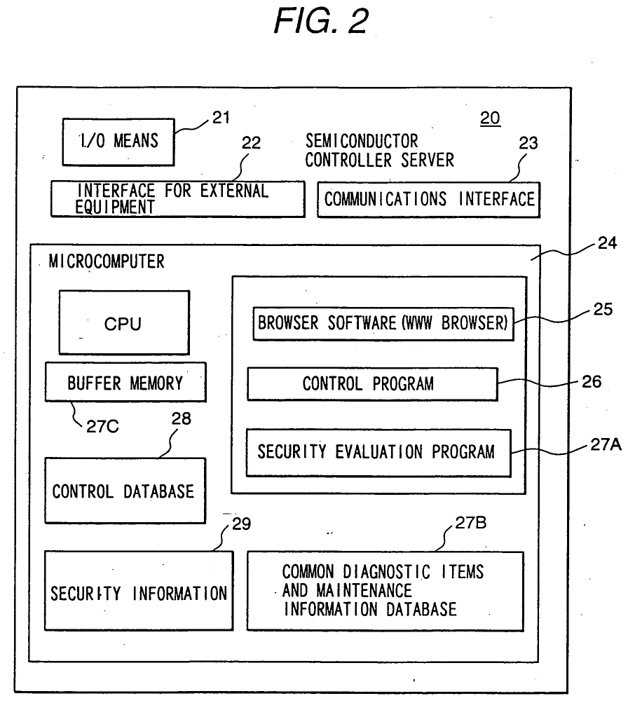

FIG. 2 is a drawing representing an example of configuration of the semiconductor manufacturing system control server 20 in the system of FIG. 1.

The semiconductor manufacturing system control server 20 is composed of a personal computer, for example, and is connected with a display and operation unit as an I/O means including a keyboard and mouse. It is also provided with an interface 22 for connection with the external equipment, and communications interface 23. A browser software (WWW browser) 25 for access to the Internet 50 through server 40 and connection with server 60 is held by the storage means of the microcomputer having a CPU.

Furthermore, it comprises a program 26 required for administration and control of the semiconductor manufacturing system 10 (10A to 10N) and for production management, database 28, security level evaluation control means 27 (security evaluation program 27A, data on common items for diagnosis, database 27B for information on maintenance, buffer memory 27C for temporary storage of information for which Company B has the right of access, general security information database 29, etc.

The security level evaluation control means 27 of the semiconductor manufacturing system control server 20 is determines the scope of providing the data on the semiconductor manufacturing system which is requested by Company B for periodic or temporary remote diagnosis, namely, access right.

The security level evaluation control means 27 is also equipped with a recipe 25 format change function to change a recipe in order to provide the required data to Company B with security protected. Such information for which Company B has a right to access is temporarily stored in the buffer memory 27 only during diagnosis. The diagnostic system of Company B is allowed to access the semiconductor manufacturing system control server 20 only for the information retained in the buffer memory 27C. Furthermore, the information which allows the buffer memory 27C to be accessed by the diagnostic system of Company B is retained, for example, by the security information database 29.

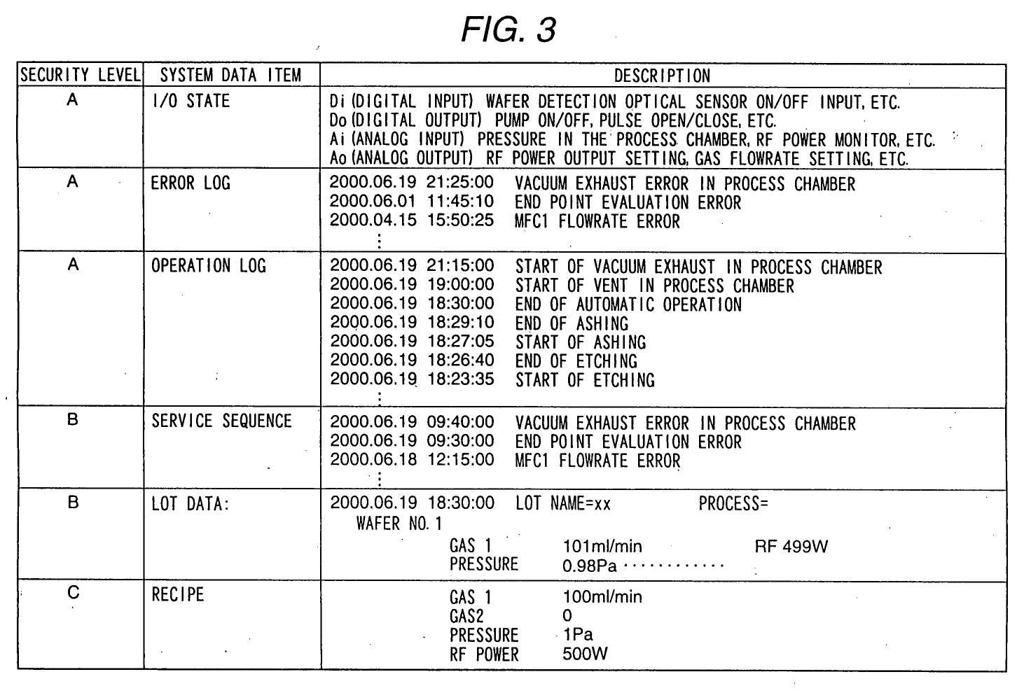

FIG. 3 shows an example of the table representing the information security level on the side of Company A regarding the semiconductor manufacturing system of Company A retained in the database 27B of the information security evaluation means 27. This example shows the security level divided into three levels; A, B and C. Level C exhibits the highest order of security.

“Error log” in the table signifies the code giving time-series representation of information error having occurred in the system. “Operation log” denotes a record of the operation details of the semiconductor manufacturing system with time before the start of diagnosis. “Service sequence” means a program which routinely checks if a system, e.g., the semiconductor manufacturing system of Company A is normal or not. Generally, the client side of the system runs the program on a periodic basis to check the system status.

“Lot data” indicates the code which records the result of processing subsequent to processing of the semiconductor manufacturing system of Company A. Normally, it records the amount of monitor corresponding to a recipe item. For example, there is information to shows that the flow rate monitor indicates 101 ml/min. in contrast to the flow rate setting of 100 ml/min. “Recipe” is the record information describing the object conditions of the product.

Level A in the table shows that Company B has a right of access at all times on condition of security protection. In other words, information on level A is provided whenever requested by Company B. Levels B and C show that Company B has no access right in principle. If there is a request from the diagnostic system of Company B, whether access right is assigned on condition of security protection or not is determined according to the specific event. When the system is purchased from Company B or a support agreement is signed, these levels are determined as a basic data security level in the system, together with security protection matters, according to the relation between client Company A and Company B. They are then converted into data. The right of Company B to access the information of levels B and C is changed according to economic loss due to production failure resulting from failure, urgency and loss resulting from disclosure of information. In this manner, the security evaluation means 27 determines the access right of Company B, in other words, the scope of providing information according to the preset security level and specific event.

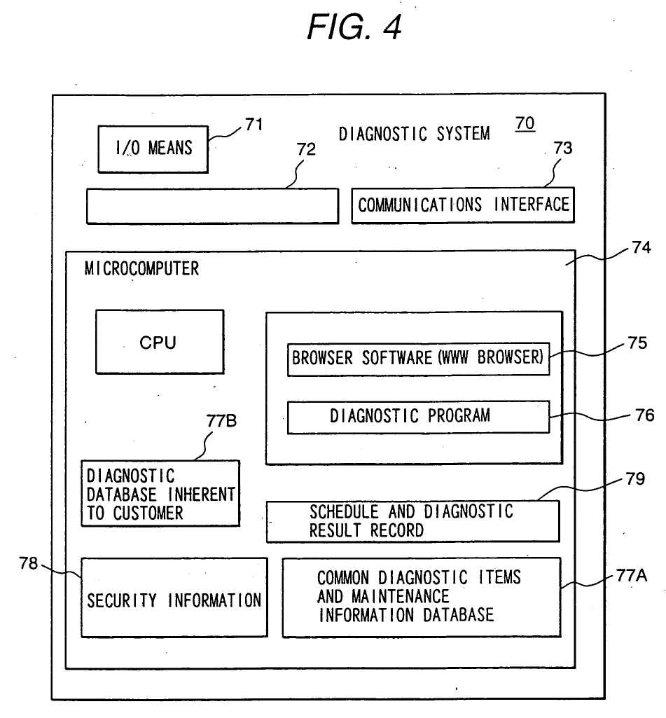

FIG. 4 is a drawing showing an example of the configuration of diagnostic system 70 in the system shown in FIG. 1. The diagnostic system 70 is composed of a personal computer, for example, and is connected with a display and operation unit as an I/O means including a keyboard and mouse. It is also provided with an interface 72 for connection with the external equipment, and communications interface 73. The microcomputer 74 has a CPU and various storage means, which store browser software (WWW browser) 75 for access to the Internet 50 and connection with server 40 and diagnostic program 76 for remote diagnosis. It is also provided with (1) a database 77A for system diagnosis information including the error code of the system and maintenance information, (2) a database 77B for regular or irregular diagnosis inherent to client Company A, (3) an information database 78 for related to security required to get diagnostic information regarding the system of Company A and (4) a database 79 recording the diagnostic schedule and diagnostic results.

The diagnostic system 70 makes an inquiry about the information regarding the facilities of Company A where said information is assigned with access right in advance. Then it conducts diagnosis based on the obtained information. Furthermore, it requests said first company to provide additional information on the high order security level not assigned with access right, if additional information is required for said diagnosis, and performs diagnosis based on the additional information obtained by being assigned with a new access right.

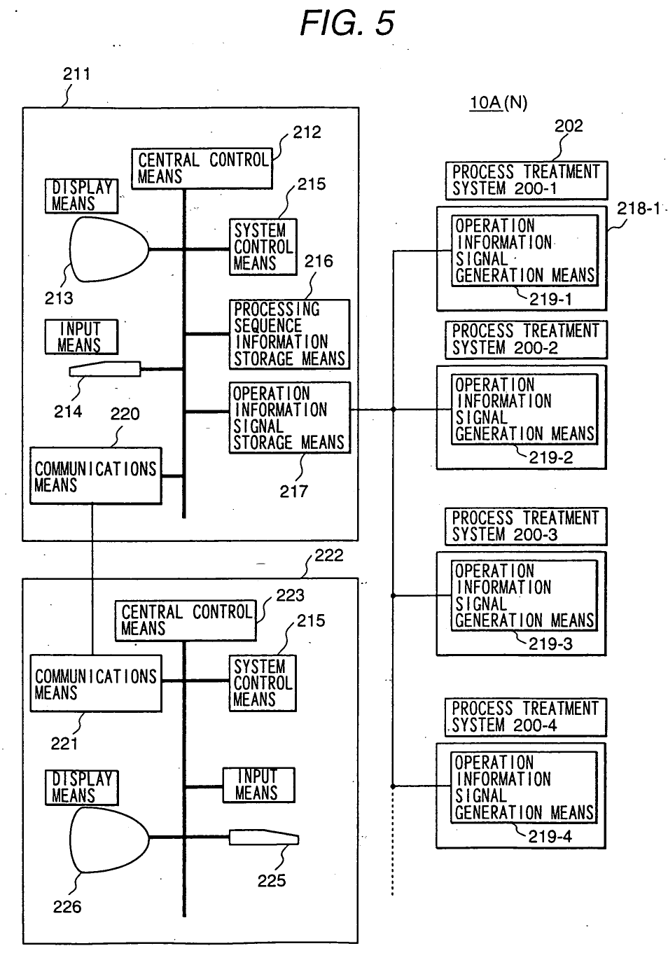

FIG. 5 shows an example of control configuration of the semiconductor manufacturing system 10 in the system of FIG. 1. Numeral 211 denotes the main control unit of the entire system. FIG. 5 shows any one of 10A to 10N. Numeral 212 indicates a central control means to provide general control. It can be a CPU, for example. Numeral 213 is a display means to display the settings of operation status and operation conditions, and operation start/end. It can be a CRT, for example. Numeral 214 denotes an input means used to set operation conditions and to enter the operation start command, process treatment conditions and maintenance operation input. This input means can be a keyboard, for example. Numeral 215 signifies a system control means. It evaluates the operation information signal status showing the operation of the above-mentioned process treatment systems 2-1 to 2-4 is enabled not. It stores the procedure of allowing the operation to be continued by another process treatment system without relying on said process treatment system, even if any one of process treatment systems 202-1 to 202-4 is disabled during automatic operation. A ROM is an example of this means. Numeral 216 denotes a processing sequence information storage means to store the wafer processing sequence in the vacuum processing system. It is exemplified by a RAM. The data entered by the operator using the display means 213 and input means 214 prior to start of the operation is stored as this wafer processing sequence. Numeral 217 shows an operation information signal storage means. It stores operation information signal which indicates that the operations of process treatment systems 202-1 to 202-4 are enabled or not. It is exemplified by a RAM. Numerals 202-1 to 202-4 denote a process treatment system to handle wafer processes. This treatment system can be of any type if it performs any one of wafer process treatment steps such as etching, post-processing, film formation, sputtering, CVD and water treatment.

Numerals 219-1 to 219-4 denote an operation information signal generation means to produce operation information signals showing that the operation of process treatment systems 202-1 to 202-4 is enabled or not. In the present embodiment, it is installed on the process treatment system, but can be installed at any place.

Numerals 220 and 221 denote a communications means, and serves to connect between the main controller 211 to provide the entire system and auxiliary operation panel 222. Auxiliary operation panels 222, 225 and 226 are used for above-mentioned applications. Numeral 224 is a terminal control means which stores the processing procedure to control the terminal functions of the auxiliary operation panel. Numeral 223 indicates a central control means to control above-mentioned 221 and 224 to 226, and is composed of a CPU, for example.

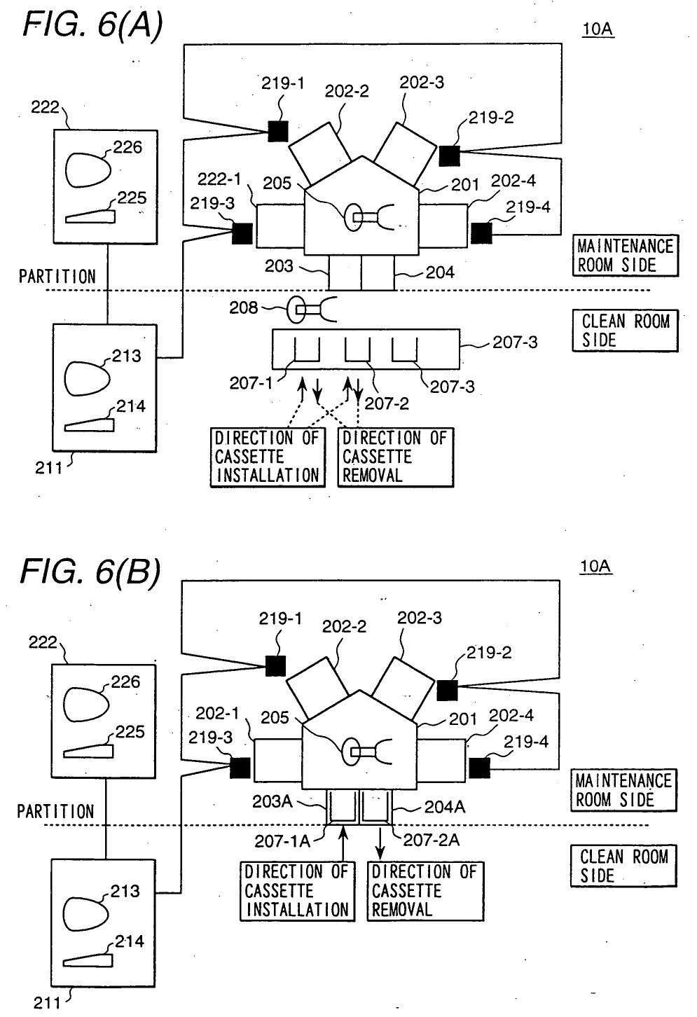

FIG. 6 shows an example of a vacuum processing system adopted as process treatment systems 202-1 to 202-4 given in FIG. 5. In FIG. 6(A), 201 is a transfer chamber to transfer wafers. Wafers in the load lock chamber are fed to the process treatment systems 202-1 to 202-4 according to the wafer transfer schedule. Furthermore, wafers having been processed by the process treatment system are transferred to the next process treatment system, and wafers having undergone the entire process treatment are transferred to the unload lock chamber. Numerals 202-1 to 202-4 show a process treatment system to provide process treatment. Process treatment includes the entire wafer process treatment such as etching, post-processing, film formation, sputtering, CVD and water washing. Numeral 203 indicates a load lock chamber which is used to carry wafers into the transfer chamber 201 from the atmosphere transfer system 206. Numeral 204 indicates an unload lock chamber used to carry wafers from the vacuum process chamber into the atmosphere transfer system 206. Numeral 205 indicates a vacuum robot installed in the transfer chamber 201 and used to transfer wafers. Numeral 206 shows an atmosphere transfer system to install the wafer storage cassette. Numeral 207 denotes a cassette to store the wafer to be processed. It is a cassette to store wafers for products or to store wafers for cleaning. Numeral 208 denotes an atmosphere robot to unload wafers from the cassette over the atmosphere transfer system and to transfer them into the load lock chamber 203. It is also used to feed wafers from the unload lock chamber 204 back into the original cassette.

FIG. 6(B) shows an another embodiment representing a vacuum processing system. A process treatment system is connected to the transfer chamber 201, and the cassette to transfer wafers into the processing system is installed in the load lock chamber 203A of the processing system. Wafers are taken out one by one from the cassette, and are loaded into the processing system to be processed therein. More process treatment systems can be connected. The system configuration can be shown by eliminating from the configuration shown in FIG. 6(A) the atmosphere transfer system 206 for installation of the cassette accommodating the wafer and the atmosphere robot 208. The function and configuration of each piece of equipment are the same as those given in FIG. 6(A), except that wafers are unloaded from the load lock chamber 203A, instead of from the cassette, and are loaded into the unload lock chamber 204A, instead of into the cassette.

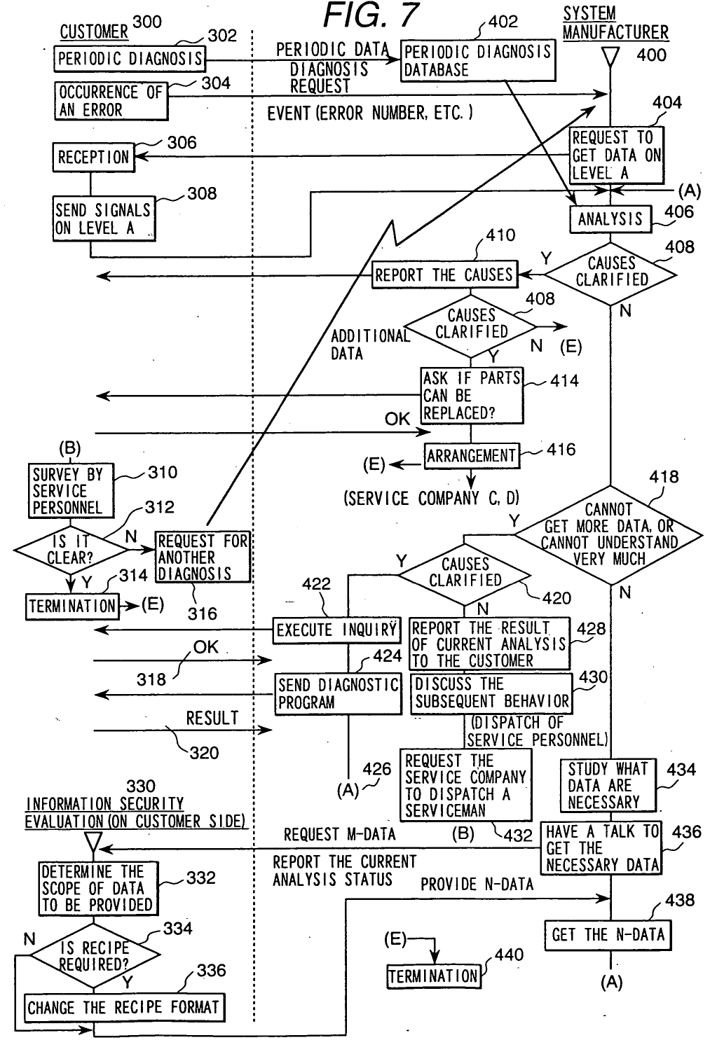

Using FIG. 7, the following describes a processing flow where a system manufacturer diagnoses a semiconductor manufacturing system of a client: Diagnosis can be divided into two types; a regular diagnosis and irregular diagnosis to be conducted whenever an error occurs.

In regular diagnosis, the client A sends the status data or regular diagnostic data to the system manufacturer B through the server and the Internet (302). The data is stored in the database for regular diagnosis of system manufacturer B (402). When an error has occurred, on the other hand, diagnosis request specified in the form of error event, error number, etc. is sent from client A to system manufacturer B via the Internet. The time of diagnosis can be can be notified from system manufacturer B to client A in advance.

If there is a request for regular or irregular diagnosis from client A, the diagnostic system 70 of the system manufacturer B starts the diagnostic program to initiate a remote diagnosis of the semiconductor manufacturing system 10 of the client A.

The diagnostic program requests the semiconductor manufacturing system control server 20 of client A (hereinafter referred to as “client A”) to get data on level A (404). Client A receives this request (306), and determines the scope of data (308) by making reference to the security level preset by the security evaluation means 24. Data on level A is sent to Company B on condition of security protection for the data.

Based on the data on level A, information for system diagnosis such as the error code of the system, maintenance information database and diagnostic database unique to the client, the diagnostic program starts diagnosis on the semiconductor manufacturing system 10 of client A, and analyzes the causes for failure (406). When the causes have been analyzed (408), causes are sent to the client A (410). Furthermore, the diagnostic program evaluates if the component must be replaced or not (412). If component replacement is not required, the system goes to the step of termination (440) to terminate diagnostic processing. Termination information is also sent to the client, and the system goes to the step of termination (314) to perform the processing required upon termination of diagnosis, for example, deletion of data of the buffer memory 27C.

If component replacement is required, an inquiry is sent to client A asking if the component can be replaced or not (414). If client A sends back a reply of approval, arrangement is made for component replacement. To put it specifically, notifies is given to the component replacement service companies C and D to replace the component. Then the system proceeds to the step of termination (440) to complete diagnostic processing.

Information on termination is also sent to the client, and the system goes to the step of termination (314).

When the cause for analysis cannot be found out, evaluation is made to see if more data required for analysis can be provided by client A (418). If it is assumed that no more data can be obtained, or it is not clear whether more data can be obtained or not, evaluation is made to determine whether or not test running is to be conducted (420). For example, there are cases where there is no prospect of getting more adequate information regarding a specific event after request has been made for submission of additional information on the high order security level not assigned with access right. It is difficult to make all these evaluations automatically. Actually, the operator of the diagnostic system evaluates the general situation and enters the result into the diagnostic system.

If it has been evaluated that test running should be performed, an inquiry is sent to the client A to show the evaluation (422). If a reply of approval is given by client A (318), a diagnostic program for specific diagnosis is sent to client A (424) to get the result (320). In addition to the information on this result, analysis processing is carried out again (406).

Even if the causes for failure cannot be found out by the above-mentioned analysis, analysis is made to find out what are the required data (434) if data required for analysis is provided by the client A. Then negotiation is made with the client A to get the required data (436). Let us assume that m pieces of additional data are necessary.

If there is a request to get this data, the information security evaluation means 27 of client A determines whether a new access right is assigned or not in response to preset security level and specific event. In other words, it determines the scope of data to be supplied to Company B (332).

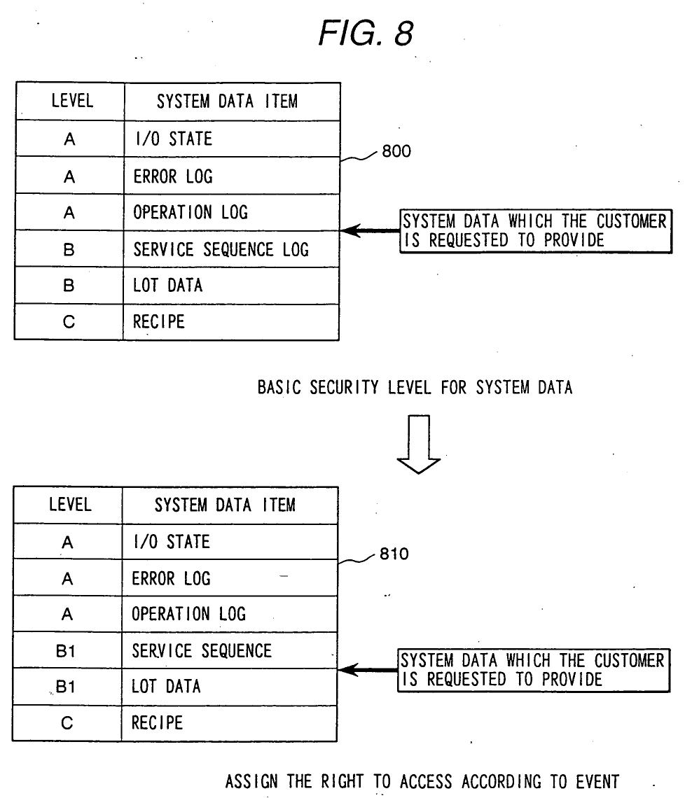

As shown in FIG. 8, the information security evaluation means 27 changes the access right in conformance to a specific event. When the system is purchased or a support agreement is signed, this level is determined as a basic data security level in the system in the form of a security protection agreement according to the relation with the client. After that, access right to the system data required of the client is changed automatically or with operator's judgment, depending on the details of the support. Then data is provided on condition of security protection.

FIG. 8 shows an example of evaluation as an Object B in response to a specific event where a new access right is assigned for “Service sequence” in the level B.

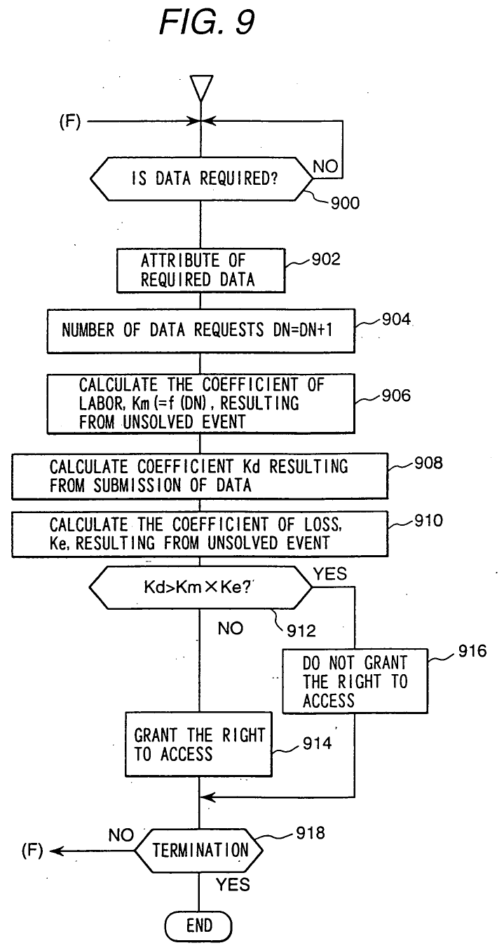

FIG. 9 shows an example of a specific flow of the process of allowing automatic change of the security level by the information security evaluation means 27 of client A (step 332 in FIG. 7), when there is a request to get data for the scope without access right in step 436 shown in FIG. 7. If there is a request to get data (900), the information security evaluation means 27 collects data on the attribute of the required data and semiconductor production size (902). Further, it updates the DN showing the number of requests regarding the same or different data (904). Then labor coefficient Km for event solution as a function of the DN for the number of requests is calculated (906). The loss coefficient Kd accompanied by the supply of information (908) is calculated from the attribute data of the required data. The next step is to digitize the economic loss when the event is not solved from the data of semiconductor production size (Ke) (910). Then Kd is compared with Ke×Km (912). If there is a big economic loss, a new access right is assigned, the required data is stored in the buffer memory; then data is sent to the requesting party (914). If economic loss (Ke×Km) is small, the current access right is retained unchanged, and the request for submission of data is rejected (916). When a series of diagnostic processing has terminated, this processing terminates (918).

Above-mentioned loss coefficients Kd, Ke and Km show only one example. It is also possible to make evaluation by calculating coefficients using a combination of other parameters. To simplify calculation, it is possible to form a table by a combination of some parameters in advance. It is also possible for the operator to make evaluation of step 912. For example, referring to the information in the above-mentioned table, the operator makes a final evaluation as to the assignment of access right. The result of this evaluation is entered into the information security evaluation means 27.

Going back to FIG. 7, evaluation is made to determine whether the recipe is required or not (334), when the data assigned with a new access right is to be supplied. If it is required, recipe format is converted for the purpose of security protection, and is stored in the buffer (336).

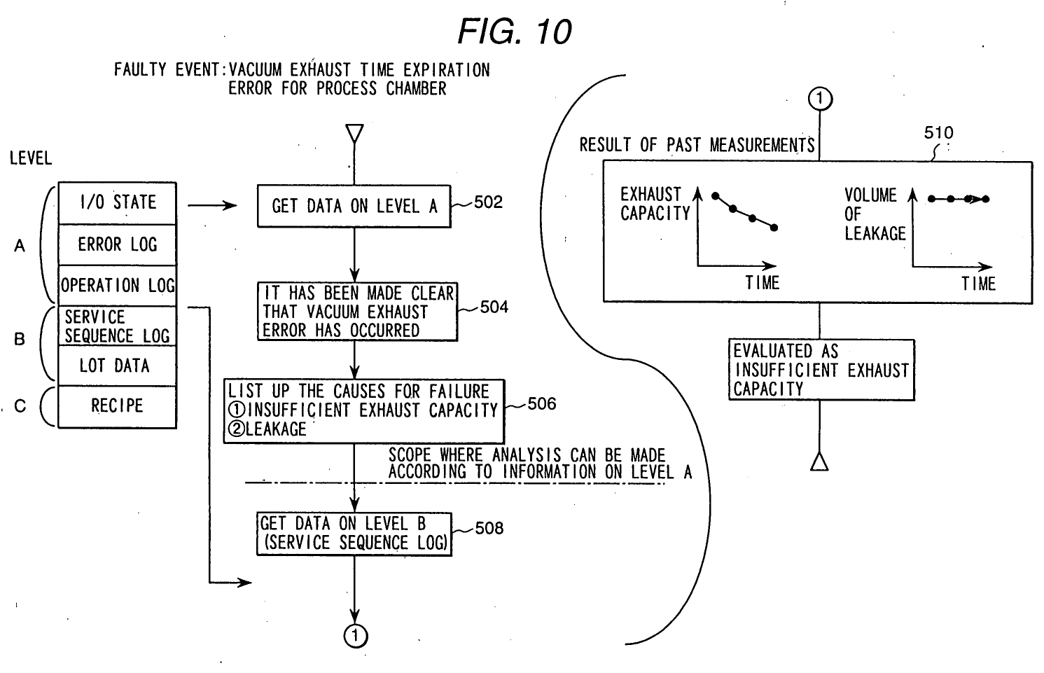

FIG. 10 shows an example of changing the recipe format. The original recipe on the left shows raw data on the client side. This is converted into the form as shown in the selection conversion recipe on the right side. It is natural that the selection conversion recipe includes information sufficient to perform diagnostic processing in the diagnostic program of Company B although the details of the raw data cannot be known. In this manner, Company B can get n pieces of additional data from the client A (438).

In addition to this added data, diagnosis is again started on the semiconductor manufacturing system 10 of the client A to analyze the failure (406). If the cause is analyzed (408), the cause is notified to client A (410). Similar processing is repeated thereafter.

As a result of running the test (420), the current result of analysis is reported to the client (428), and discussion is made on subsequent behavior (430). For example, discussion is made as to the necessity of dispatching a service person. If dispatching is necessary, request is sent to the service company to dispatch the service person (432). If causes have been found out by the service person (310), necessary steps are taken for termination (314). Processing is now complete. This step of termination includes the step of reporting to Company B that the causes have been found and necessary steps must be taken taken by the client A. The result of termination is notified to Company B as well, and the result is recorded in the database of the diagnostic system of Company B. The process of diagnosis is now complete (440). In the step of termination, diagnostic information and result gained from the client A are processed to ensure that security protection can be provided as requested by the client, or is deleted from the storage unit.

If causes are not clear, request for diagnosis is made again from the client A to Company B based on the additional data gained through checkup by the service person (316). In response to this request for diagnosis, diagnostic processing in step 404 and thereafter is started.

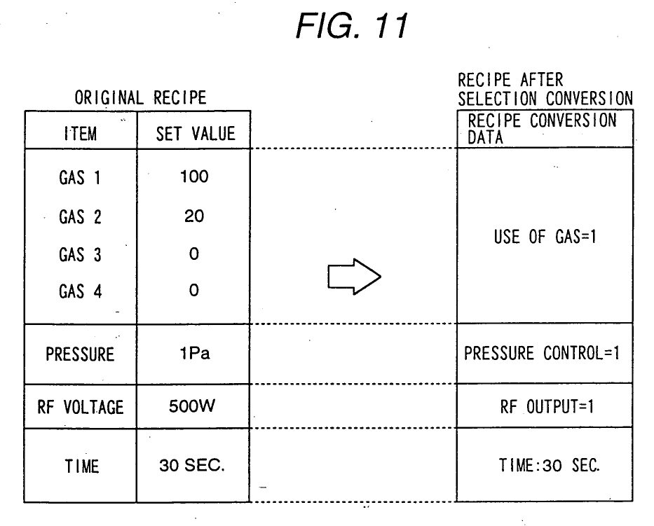

FIG. 11 shows an example of analysis where failure event is a vacuum exhaust time expiration error in the process chamber of the semiconductor manufacturing system. If failure has occurred, the data on level A is collected to analyze the causes for failure. In the present example, data on level A includes I/O state, error log and operation log as shown in FIG. 3. As a result of analysis, it is found out from the error log and operation log that vacuum exhaust error has occurred. Then the database is searched to list up the possible causes for failure. Namely, <1>sufficient exhaust capacity and <2>leakage are listed up, and are notified to client A. If they are within the scope analyzable based on the information on the level A, diagnostic processing terminates. If analysis is not possible, the right of access to data on the level B is gained and the data of the service sequence log is obtained. The service sequence log contains the data shown in FIG. 3. It is used to check and compare the past measurements and current situation to clarify that exhaust capacity is reduced. This makes it clear that cause for the failure is “Vacuum exhaust error has occurred”. This is notified to the client A, and necessary actions are taken.

In this way, data collection, diagnosis and, if required, checkup by service person are carried out in conformance to the security level and specific event. Then even if failure has occurred to the system, quick analysis is made and adequate remedial action is taken in almost all cases. From the view point of the client A, leakage of security data is minimized in diagnosis and the result of quick analysis is obtained. This will result in minimized economic loss.

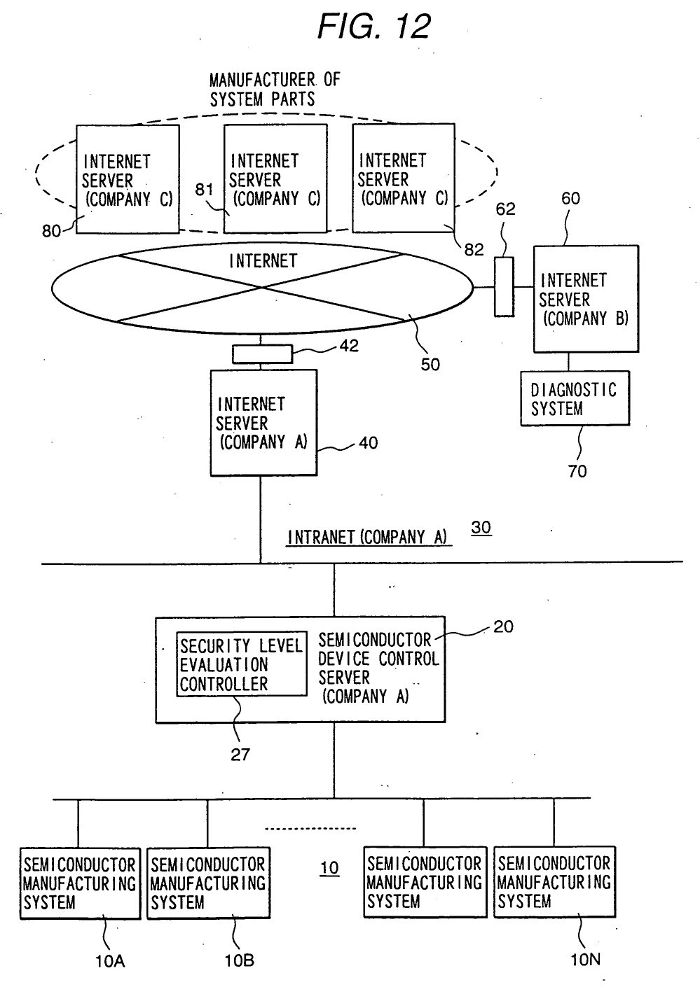

FIG. 12 is a block diagram representing another embodiment of the remote diagnostic system where the present invention is applied to the semiconductor manufacturing system. This system is used by the manufacturing manufacturer or Company B as a service company to make a remote diagnosis of the entire semiconductor manufacturing system of Company A periodically or whenever required, with the cooperation of system component manufacturers C, D and E, using the diagnostic program.

In this remote diagnostic system, the semiconductor manufacturing system 10 (10A to 10N) of Company A which is the object of faulty diagnosis and data updating is connected to the semiconductor manufacturing system control server 20 of Company A. Server 20 is connected to the Intranet 30 in the Company A, and is further connected to the Internet 50 through the Internet server 40 and Firewall system 42. The diagnostic system 70 loaded with the diagnostic program of the semiconductor manufacturing system is connected to the Internet 50 through the Firewall system 62 of Company B and the Internet server 60 (and the Intranet). The Internet 50 is connected to the server and database related to the components of the component manufacturers C, D and E of the semiconductor manufacturing system through the Firewall system and the Internet servers 80, 81 and 82 (and the Intranet).

The server related to components of the component manufacturers C, D and E comprises;
(1) a storage unit which stores information classified into multiple security levels having different access rights in order to determine the scope of reply in response to an inquiry regarding information on diagnosis of said facilities, and
(2) a security level evaluation control means to assign a new access right in response to the inquiry about diagnosis from Company B devoid of access right in conformance to the degree of the event related to said inquiry.

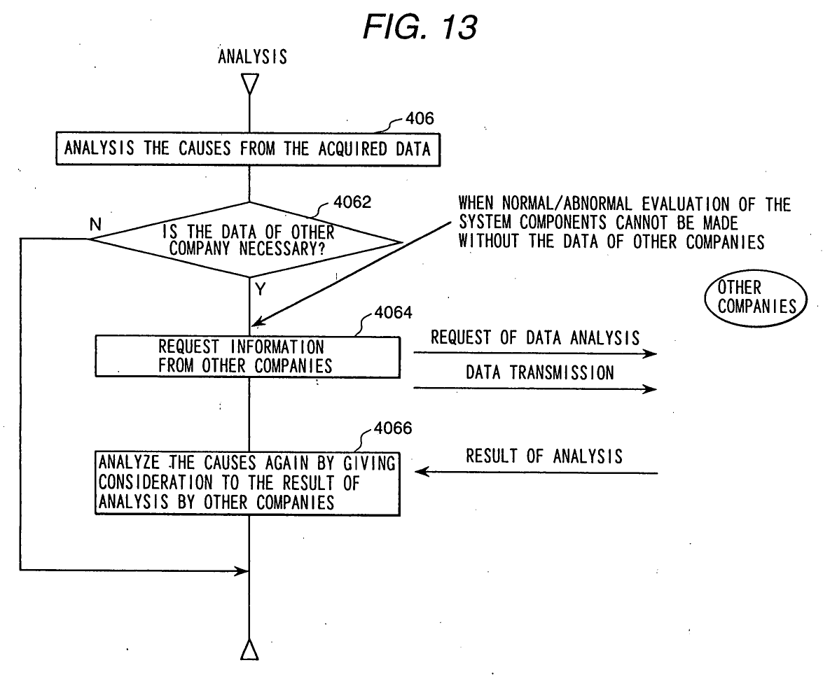

In this embodiment, steps 406 to 408 shown in FIG. 7 are slightly different. Namely, in step 406, the causes for failure is analyzed according to the data acquired from the client, as shown in FIG. 13. Evaluation is made to determine whether information of other companies devoid of access right is necessary or not (4062). If causes are not clear and the normal/abnormal state of the system configuration components cannot be evaluated without the data of other companies devoid of access right, inquiry is made of other companies (4064). This inquiry contains request of data analysis and request of data transmission. When a new access right is assigned, causes are analyzed again (4066), with consideration given to a new data and the result of analysis by other companies.

In the steps described above, Company B can make a remote diagnosis of the semiconductor manufacturing system of Company A periodically or whenever required, with the cooperation of system component manufacturers C, D and E, using the diagnostic program. In this case as well, data collection, diagnosis and, if required, checkup by service person are carried out in conformance to the security level and specific event. Then even if failure has occurred to the system, quick analysis can be made and adequate remedial action can be taken in almost all cases. From the view point of the client A and system component manufacturers C,D and E, leakage of security data is minimized in diagnosis and the result of quick analysis is obtained.

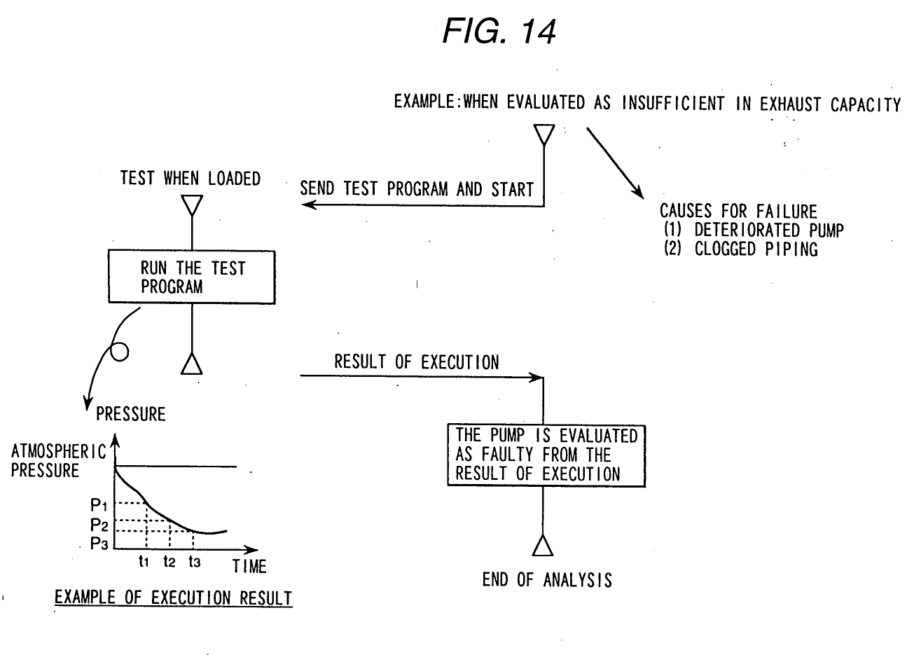

FIG. 14 is a flow diagram in the case where the diagnostic program is sent and processed in step 424 shown in in FIG. 7. For example, if the diagnostic system is found out to have an insufficient exhaust capacity as a result of analysis, causes for failure can be <1>pump deterioration and <2>clogging of the piping. As an example of running the test program in this case, software to measure the pressure change after setting the pump pressure to the atmospheric pressure and starting exhaust is sent. The related test program is sent to the semiconductor manufacturing system control server 20 of client A. This test program is started and run on the semiconductor manufacturing system 10 (10A to 10N) where failure is anticipated.

Since the related mode is not a normal operation mode, such software is usually not contained in the semiconductor manufacturing system proper. Only at the time of diagnosis, the software is downloaded from the server 20 in the semiconductor manufacturing system 10 of the client, and the test program is run. In this embodiment, an error is found in the trend of pressure reduction according to the result of running the test program, as illustrated. This leads to the conclusion that the failure is caused by pump deterioration. Thus, causes for failure have been found out quickly and accurately to terminate the analysis. This test program is not required in the normal operation mode, and is deleted automatically in the semiconductor manufacturing system 10 upon completion of diagnosis.

The above has described examples of the present invention being applied to the semiconductor manufacturing system. The scope of application of the present invention is not restricted to them alone. For example, it can be extensively applied to the diagnosis of facilities in cases where the companies different from the users of the production facilities in the chemical plant and automobile production line, and such facilities as found in the power generation plant and financial system are engaged in the production, and the users have their own trade secrets in the use of such facilities.

The present invention provides a remote diagnostic system and diagnostic method having an elastic, highly reliable security function to ensure harmony between two requirements of protection of company security and prevention of increased economic loss in the remote diagnosis of facilities.

1. A remote diagnostic system for facilities which carries out a diagnosis on the facilities placed under the management of the first company, using the diagnostic system of the second company which is connected to said facilities through a communications network and which is not placed under the management of said first company;
wherein said facilities comprise a security level evaluation control means which changes the scope of reply in response to an inquiry from said diagnostic system regarding information on said facilities for diagnosis in conformance to the degree of the event related to said inquiry.

2. A remote diagnostic system for facilities which carries out a diagnosis on the facilities placed under the management of the first company, using the diagnostic system of the second company which is connected to said facilities through a communications network and which is not placed under the management of said first company, where said facilities include the systems manufactured by said second company and third company;
wherein said facilities of said first company comprises,
a storage unit which stores said information classified into multiple security levels having different access rights in order to determine the scope of reply in response to an inquiry regarding information on diagnosis of said facilities, and
a security level evaluation control means to assign a new access right in response to the inquiry devoid of access right regarding said diagnosis from said second company in conformance to the degree of the event related to said inquiry;
wherein the server of said third company comprises,
a storage unit which stores said information classified into multiple security levels having different access rights in order to determine the scope of reply in response to an inquiry from the diagnostic system of said the second company regarding information on diagnosis of said facilities through communications network, and
a security level evaluation control means to assign a new access right in response to the inquiry devoid of access right regarding said diagnosis from said second company in conformance to the degree of the event related to said inquiry;
wherein the diagnostic system of said the second company conducts a diagnosis of the said facilities based on the information gained from said first company and third company.

3. A remote diagnostic system for facilities which carries out a diagnosis on the facilities placed under the management of the first company, using the diagnostic system of the second company which is connected to said facilities through a communications network and which is not placed under the management of said first company;
wherein the diagnostic system of said second company makes an inquiry about the information regarding the facilities of said first company where said information is assigned with access right in advance, and conducts diagnosis based on the obtained information,
requests said first company to provide additional information on the high order security level not assigned with access right, if additional information is required for said diagnosis, and
performs diagnosis based on the additional information obtained by being assigned with a new access right from said first company.

4. A remote diagnostic system for facilities which carries out a diagnosis on the facilities placed under the management of the first company, using the diagnostic system of the second company which is connected to said facilities through a communications network and which is not placed under the management of said first company, where said facilities include the systems manufactured by said second company and third company;
wherein the diagnostic system of said second company
inquires of said first company and said third company about the information regarding the facilities of said first company where said information is assigned with access right in advance, and conducts diagnosis based on the obtained information,
requests said first or third company to provide additional information on the high order security level not assigned with access right, if additional information is required for said diagnosis, and
performs said diagnosis based on the additional information obtained by being assigned with a new access right.

5. A remote diagnostic system for facilities according to any one of the claim 1, wherein the right of access to said information is classified into at least two levels;
the scope of normally providing information in response to the inquiry from said the second company, and
the scope of restricting said access right in conformance to the degree of said event.

6. A remote diagnostic system for facilities according to any one of the claim 1, wherein the right of access to said information is classified into at least three levels;
the scope of normally providing information in response to the inquiry from said the second company,
the scope of restricting said access right in conformance to the degree of said event, and
the scope of providing information by restricting said access right and changing the information provision format for security protection.

7. A remote diagnostic system for facilities according to any one of the claim 1, wherein the diagnostic system of said the second company conducts said diagnosis by adding new information regarding said facilities provided by maintenance or service personnel to said information.

8. A remote diagnostic system according to any one of the claim 1, wherein said facilities are semiconductor manufacturing systems.

9. A remote diagnostic system for facilities which carries out a diagnosis on the facilities placed under the management of the first company, using the diagnostic system of the second company which is connected to said facilities through a communications network and which is not placed under the management of said first company;
wherein the diagnostic system of said second company
makes an inquiry about the information regarding the facilities of said first company where said information is assigned with access right in advance, and conducts diagnosis based on the obtained information,
requests said first company to provide additional information on the high order security level not assigned with access right, if additional information is required for said diagnosis, and
performs diagnosis based on the additional information obtained by being assigned with a new access right from said first company.

10. A remote diagnostic system for facilities which carries out a diagnosis on the facilities placed under the management of the first company, using the diagnostic system of the second company which is connected to said facilities through a communications network and which is not placed under the management of said first company, where said facilities include the systems manufactured by said second company and third company;
wherein the diagnostic system of said second company
inquires of said first and third companies about the information regarding the facilities of said first company where said information is assigned with access right in advance, and conducts diagnosis based on the obtained information,
requests said first and/or third company to provide additional information on the high order security level not assigned with access right, if additional information is required for said diagnosis, and
performs diagnosis based on the additional information obtained by being assigned with a new access right.

11. A remote diagnostic system for facilities according to any one of the claim 9, wherein the diagnostic system of said second company conducts diagnosis based on the information obtained by sending a diagnostic program to the facilities of said first company.
